(19) United States
(12) Patent Application Publication
(10) Pub. No.: US 2006/0023285 A1
(43) Pub. Date: Feb. 2, 2006

(54) Pixel differential polygon scanning projector

(76) Inventor: Kuo-Yen Lai, Chu-Pei (TW)

Correspondence Address: HungChang Lin, 8 Schindler Ct., Silver Spring, MD, 20903, US

(21) Appl. No.: 10/901,251

(22) Filed: Jul. 29, 2004

(51) Int. Cl. G02B 26/08

(52) U.S. Cl. 359/216; 359/204

(57) ABSTRACT

An image projection system uses multiple light sources to produce light beams reflected by a rotating multilateral drum. Each side mirror on the drum is tilted by a radial angle with respect to adjacent mirrors, and the reflected light beam of each side mirror forms one horizontal scan line. The tilted angle causes the reflected light beam to move vertically. Thus a single rotation of the single drum completes the scanning of a complete frame.

### BACKGROUND OF THE INVENTION

1. Field of the Invention

This invention relates to scanning projector, particularly to scanning projector for large screen display.

2. Brief Description of the Related Art

FIG. 1 shows a prior art scanning projector as disclosed in U.S. Pat. No. 5,687,020. A point light source 11 generates a light beam, which is focused by lenses 12 beams through a pin-hole 14; transmitted through lenses 16, 13, 22; modulated in modulator 21 with image signal generator 30; transmitted through lenses 22′, 41, 42; reflected by two rotating multilateral drums 43, 44, which are driven by motors 43a, 44a respectively; and projected on a screen 50 through lenses 45. The two reflecting drums produces two-dimensional scan of the image. The prior art projection system requires a set of two multilateral drums for scanning.

### SUMMARY OF THE INVENTION

An object of this invention is to use one single reflecting drum to effect two-dimensional scanning of the projector. Another object of this invention is to speed up scanning by scanning multiple lines simultaneously

The object is achieved by rotating a multilateral reflecting drum. The adjacent sides of the reflecting drum are tilted by a small angle in the radial direction. Multiple number of light beams are incident on the reflecting surfaces. Each side of the reflecting surface of the drum corresponds to one horizontal scan. The multiple light beams produce multiple scan lines. By offsetting the tilt angle of the reflecting sides, the scan lines are moved vertically for different sides of the drum. When the drum completes one rotation, one complete frame of the image is displayed.

### BRIEF DESCRIPTION OF THE DRAWINGS

FIG. 1 shows the prior art projection system using two reflecting drums to effect horizontal scan and vertical scan, respectively.

FIG. 2 shows the basic structure of the present invention using single offset multilateral reflecting drum projection system.

FIG. 3 shows the dot matrix display of the present invention.

FIG. 4 shows a second embodiment of the present invention.

FIG. 5 shows the dot matrix display of the second embodiment.

FIG. 6 shows a third embodiment of the present invention.

FIG. 7 shows a fourth embodiment of the present invention.

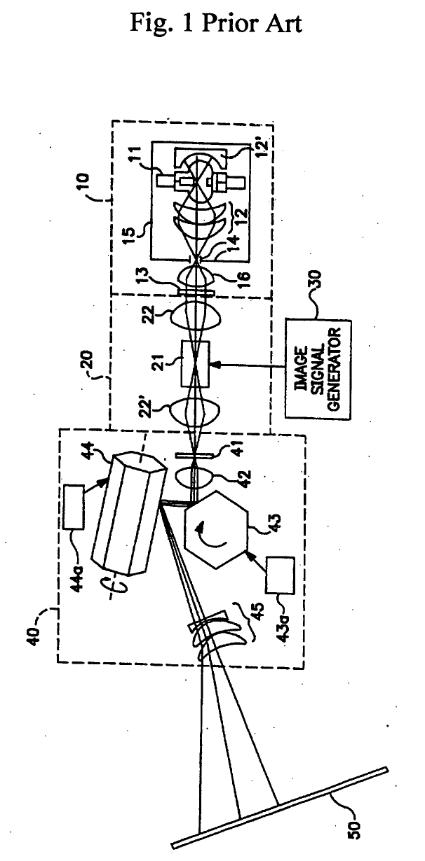

### DETAILED DESCRIPTION OF THE INVENTION

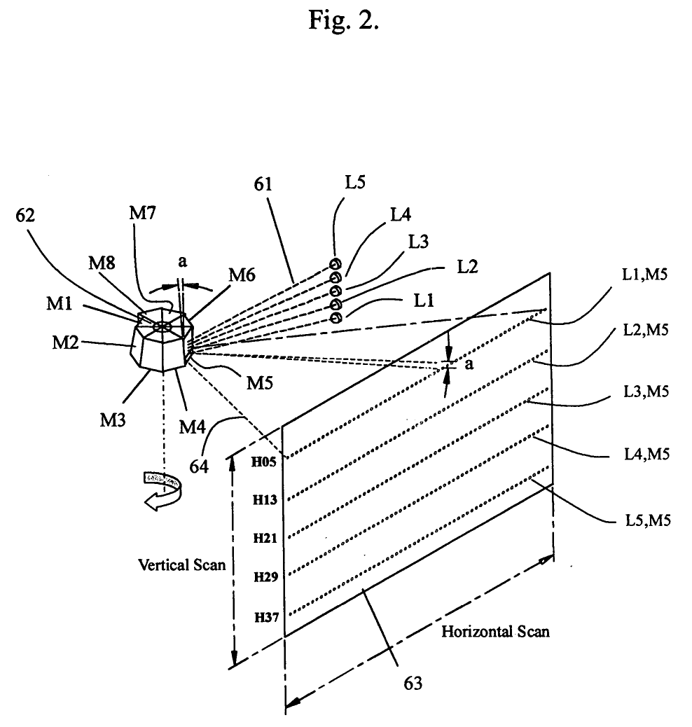

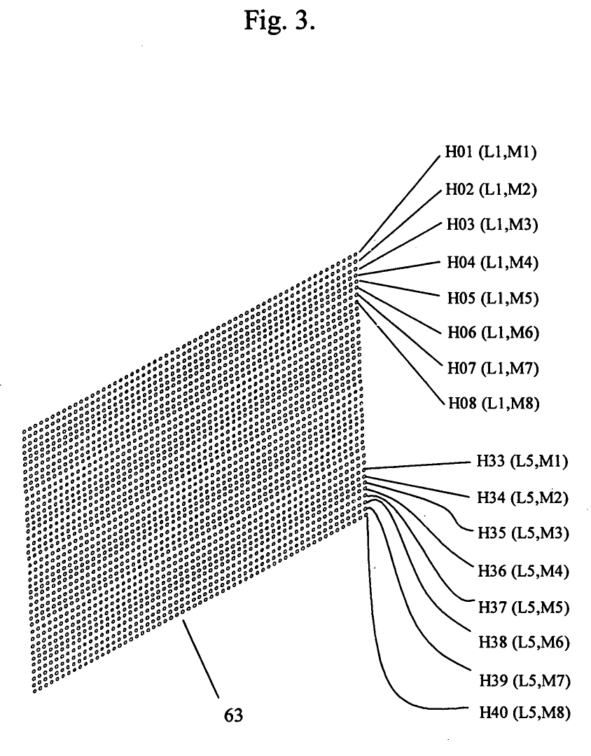

FIG. 2 shows the basic structure of the present invention. For illustration of the present invention, the display has forty horizontal (H) lines. Five light sources L1, L2, L3, L4, L5 emit totally five light beams 61 incident on a rotating reflecting drum 62. The drum has eight sides M1˜M8 as an example, each tilted by an angle “a” with respect to an adjacent side in the radial direction. Each side of the drum corresponds to one horizontal scan line. In the figure, the five light beams 61 are incident on M5 side of the drum. As the drum rotates, the five light beams scan five horizontal scan lines as shown. Not shown is a focusing lens in the path of the reflected light beams to invert the order of the light beams. Light beam L1 scans a horizontal line H05; L2, line H113; L3, H21; L4, H29; L5, H37. When the light beams scans another side of the drum, the scan lines are interleaved between the previous scan lines. When the drum completes one rotation, one complete frame 63 is scanned as shown in FIG. 3, where the first horizontal line H01 corresponds to light beam L1, reflected by side M1 of the drum; second horizontal line H02, to L1, side M2, etc.

For higher resolution, more horizontal lines, hence more side mirrors on the drum, may be used.

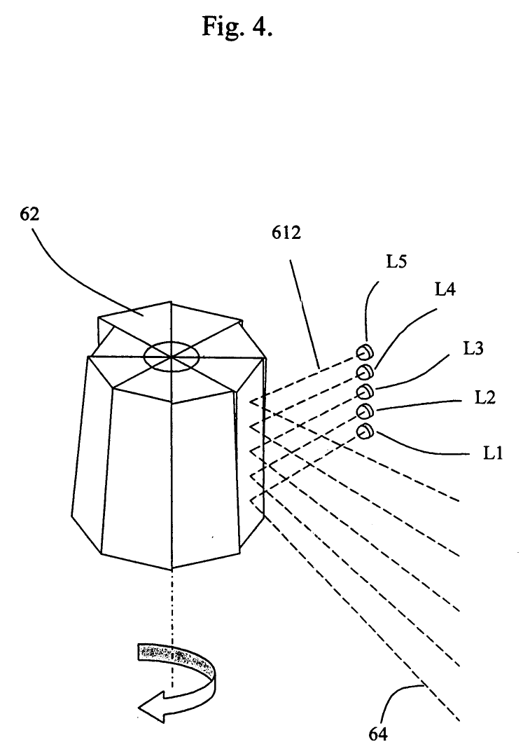

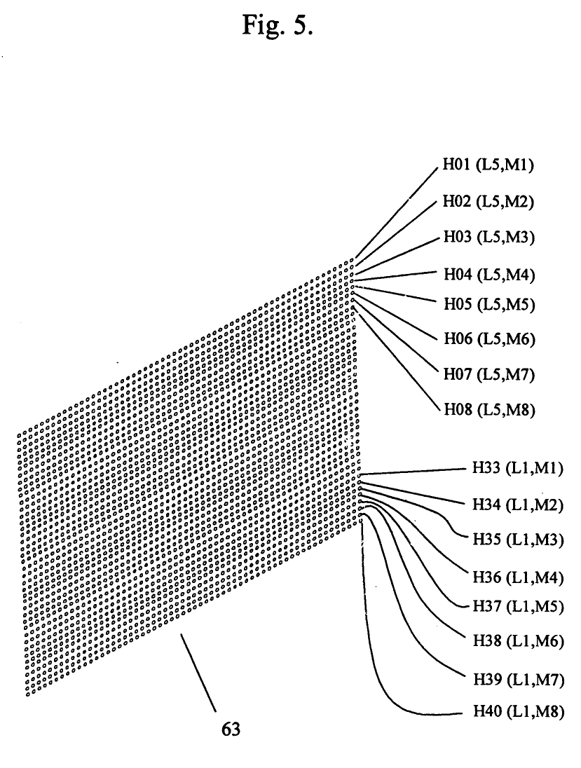

FIG. 4 shows another embodiment of the present invention. The light beams 612 from sources L1˜L5 are divergent instead of being focused as shown in FIG. 2. Otherwise, the structure is similar to that in FIG. 2 and like reference numerals refer to corresponding parts. Since the divergent light beams are not focused, the order of the light beams 64 reflected from the drum are not inverted. Thus, the resultant scan lines of the frame as shown in FIG. 5 are different from that of FIG. 3. Hence, the first scan line H001 correspond to light source L5, mirror M1; second line H02, to source L5, M2; . . . etc.

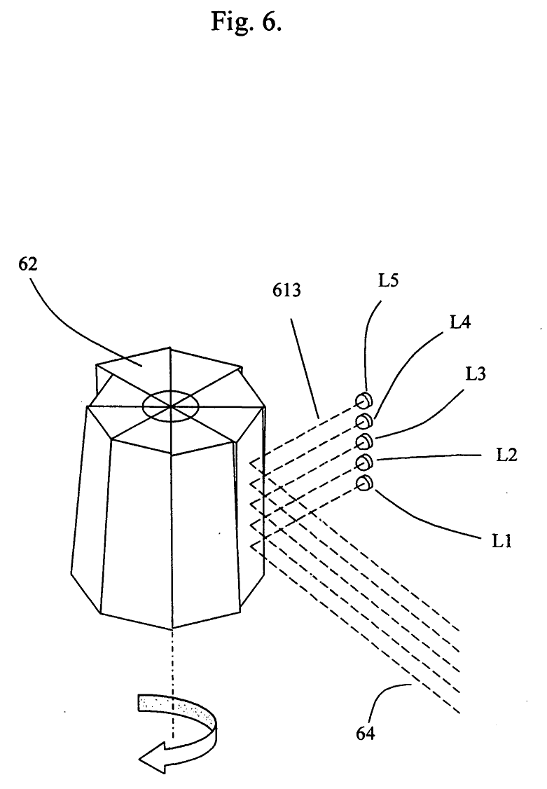

FIG. 6 shows a third embodiment of the present invention. The light beams 613 from light sources L1˜L5 are incident on the reflecting drum 62 in parallel and reflected as parallel beams 64. Otherwise the working principle is the same as that in FIG. 4. The scanning sequence is the same as that in FIG. 5.

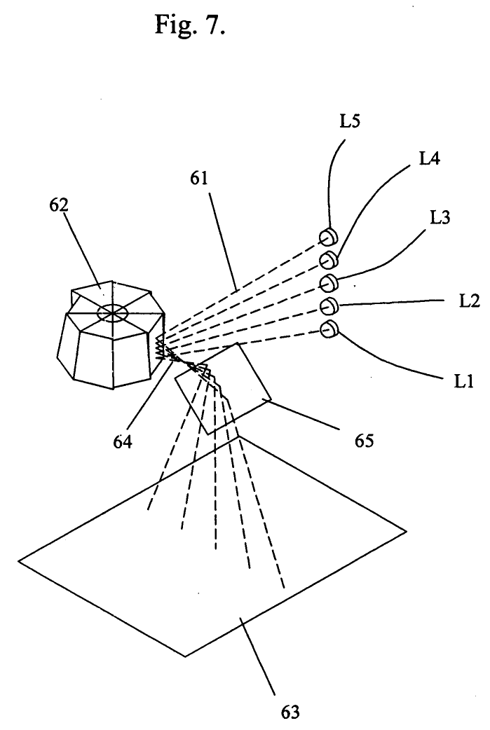

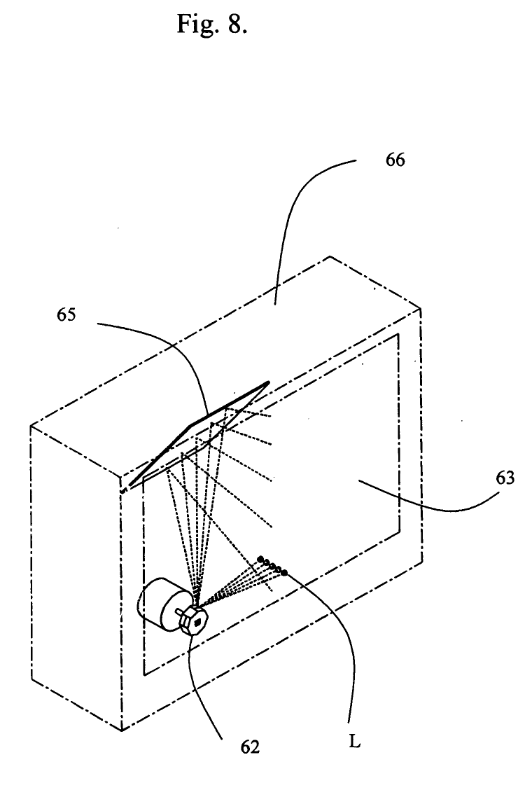

FIG. 7 shows a fourth embodiment of the present invention. The structure is similar to that in FIG. 2, except an additional reflector or lens 65 is inserted the light path 64 to change the direction of the scan on the display 63. Other reference numerals refer to corresponding parts in FIG. 2.

FIG. 8 shows a fifth embodiment of the present invention. The structure shows the installation of the parts in FIG. 7, namely the drum 62, the light sources L, reflector 65, in a cabinet 66, in which a display panel 63 is shown to form a display system similar to a traditional TV set.

While the preferred embodiment of the present invention have been described, it will be apparent to those skilled in the art that various modification may be made in the embodiments without departing from the spirit of the present invention. Such modifications are all within the scope of this invention.

1. A scanning projection system for displaying an image, comprising:
more than one light sources emitting multiple light beams;
a rotating multilateral reflecting drum having multiple side mirrors for reflecting said light beams to produce reflected light beams,
wherein each one of said mirrors are tilted by a radial angle with respect to an adjacent mirror of said mirrors,
wherein each one of said side mirrors reflects and scans one horizontal line of a picture frame, and
wherein a complete said picture frame is scanned after one rotation of the drum; and a motor for rotating said drum.

2. The scanning projection system as described in claim 1, wherein said multiple light beams are focused.

3. The scanning projection system as described in claim 1, wherein said multiple light beams are divergent.

4. The scanning projection system as described in claim 1, wherein said multiple light beams are in parallel.

5. The scanning projection system as described in claim 1, wherein the horizontal line for one side mirror is interleaved with the horizontal line for an adjacent side mirror.

6. The scanning projection system as described in claim 1, further comprising an optical device selected from the group consisting of a reflector and a lens for changing the direction of said horizontal line.

7. The scanning projection system as described in claim 6, further comprising a cabinet to enclose said projection system.
